(19) United States
(12) Patent Application Publication
(10) Pub. No.: US 2007/0069991 A1
(43) Pub. Date: Mar. 29, 2007

(54) Electron emission display and method of driving the same

(76) Inventors: Ji Won Lee, Yongin-si (KR); Duck Gu Cho, Changnyung-gun (KR)

Correspondence Address: Robert E. Bushnell, Suite 300, 1522 K Street, N.W., Washington, DC, 20005-1202, US

(21) Appl. No.: 11/474,368

(22) Filed: Jun. 26, 2006

(30) Foreign Application Priority Data
Jul. 28, 2005 (KR) 2005-69178

(51) Int. Cl. G09G 3/22

(52) U.S. Cl. 345/74.1

(57) ABSTRACT

An electron emission display capable of controlling brightness to correspond to the emission ratio of a pixel unit so as to improve contrast, prevent voltage overshoots and prevent excess power consumption. The electron emission display includes a pixel unit that displays an image that corresponds to the voltages of first and second electrodes, a data driver that receives video data and generates and transmits the data signals to the first electrode, a scan driver that transmits scan signals to the second electrode, a data processing unit that reduces the brightness of an image based on the emission ratio for the frame, and a power source supply unit that generates and outputs the driving power source. The power source supply unit changes the voltage of the driving power source from a first voltage into a second voltage in small increments when the difference between the second and the first voltage is large.

### CLAIM OF PRIORITY

his application makes reference to, incorporates the same herein, and claims all benefits accruing under 35 U.S.C. § 119 from an application earlier filed in the Korean Intellectual Property Office on 28 Jul. 2005 and there duly assigned Ser. No. 10-2005-0069178.

### BACKGROUND OF THE INVENTION

1. Field of the Invention

The present invention relates to an electron emission display and a method of driving the same, and more particularly, to an electron emission display capable of preventing rapid changes in a driving power source allowing for stable driving and a method of driving the same.

2. Discussion of the Related Art

Recently, various flat panel displays (FPD), such as liquid crystal displays (LCD), plasma display panels (PDP) and electron emission displays (EED) have been actively studied and developed. Among them, the EED includes an electron emission region that includes an electron emission device that emits electrons and an image display region that allows the emitted electrons to collide with a fluorescent layer to produce visible light. In particular, the electron emission display using carbon nanotubes is an ideal display obtained by combining the advantages of a cathode ray tube (CRT) having excellent image characteristics such as high picture quality, high resolution, and a wide view angle with the FPD that is lightweight and thin and consumes a small amount of power. In general, the electron emission device is divided into devices where a hot cathode is used as an electron source and devices where a cold cathode is used as an electron source. Electron emission devices that use a cold cathode as the electron source includes a field emitter array (FEA) type, a surface conduction emitter (SCE) type, a metal-insulator-metal (MIM) type, a metal-insulator-semiconductor (MIS) type, and a ballistic electron surface emitting (BSE) type.

The FEA type electron emission device uses a material having a low work function or a high β function as an electron emission source so that electrons can be emitted in a vacuum due to differences in electric potential. When the electron emission source has the shape of a pointed tip, carbon material such as nano material is preferably used as the electron emission source.

In the SCE type electron emission device, a conductive thin film is provided between two electrodes arranged on a substrate facing each other and minute cracks are provided in the conductive thin film to form an electron emission unit. In the SCE type electron emission device, a voltage is applied to the electrodes so that current flows to the surface of the conductive thin film and electrons are emitted from the electron emission unit at the minute cracks.

In MIM and MIS type electron emission devices, electron emission units having MIM and MIS structures are formed. When a voltage is applied between two metals or a metal and a semiconductor with an dielectric layer in between, electrons are emitted while accelerating and moving from the metal or semiconductor having high electric potential toward the metal having low electric potential.

In the BSE type electron emission device, an electron supply layer made of metal or semiconductor is formed on an ohmic electrode and an insulating layer and a metal thin film are formed on the electron supply layer so that electrons are emitted by applying a power source to the ohmic electrode and the metal thin film in accordance with a principle in which electrons are not scattered but travel when the size of semiconductor is reduced to be smaller than the mean free path of the electrons in the semiconductor.

The above-described electron emission devices can be used in various fields and have recently been actively studied due to their advantages in that they operate by emission of cathode electrode lines (self light sources, high efficiency, high brightness, wide brightness regions, natural colors, high color purity, and wide view angles) like the CRTs and that they have high operation speed and wide operating temperature ranges.

The electron emission display includes a pixel unit, a data driver, a scan driver, a timing controller, and a power source supply unit. In the pixel unit, a plurality of cathode electrodes are arranged in a column direction, a plurality of gate electrodes are arranged in a row direction, and electron emission units are provided at the intersections between the cathode electrodes and the gate electrodes to form pixels. Alternatively, the gate electrodes can instead be arranged in the column direction and the cathode electrodes can instead be arranged in the row direction. From now on, it is assumed that the cathode electrodes are arranged in the column direction and the gate electrodes are arranged in the row direction. The pixel unit is controlled by the difference in voltage between the cathode electrodes and the gate electrodes when the brightness deteriorates in accordance with the lives of the electron emission units so that more electrons are emitted from the electron emission units to compensate for brightness.

The data driver generates data signals using image signals and is connected to the cathode electrodes and transmits the data signals to the cathode electrodes. The data driver generates electrode signals for turning on and off the pixels formed at the intersections between selected cathode electrodes and gate electrodes. The scan driver is connected to the gate electrodes and selects one gate electrode from among the plurality of gate electrodes arranged in the row direction so that the data signals can be transmitted to the pixels connected to the gate electrodes. The timing controller transmits data driving control signals and scan driving control signals to the data driver and the scan driver to control the operations of the data driver and the scan driver. The power source supply unit generates power and transmits the generated power to the pixel unit, the data driver, the scan driver and the timing controller so that the pixel unit, the data driver, the scan driver and the timing controller can be driven.

When the electron emission display having the above-described structure emits light having a low brightness, the difference between a bright color and a dark color is small so that contrast and picture quality deteriorates. When all of the pixels included in the pixel unit emit light of a high brightness, the amount of current that flows through the pixel unit increases so that it is necessary for the power source supply unit to supply more power. What is needed is an improved electron emission display device that can further modify the voltages to improve contrast while preventing the need for excess power consumption while preventing malfunction caused by voltage overshoots.

### SUMMARY OF THE INVENTION

It is therefore an object of the present invention to provide an improved EED.

It is also an object of the present invention to provide an improved method of driving an EED.

It is yet object of the present invention to provide an EED and a method of driving the same that prevents power overloads for high emission ratio images.

It is still an object of the present invention to provide an electron emission display capable of controlling brightness based on emission ratio in a manner so that contrast is improved while preventing a driving voltage from rapidly changing from frame to frame so that the electron emission display can stably driven.

These and other objects can be achieved by an electron emission display that includes a plurality of first electrodes and a plurality of second electrodes, a pixel unit adapted to display an image corresponding to voltages applied to the first and the second electrodes, a data driver adapted to receive video data, to generate data signals and to transmit the data signals to the first electrodes, a scan driver adapted to transmit scan signals to the second electrodes, a data processing unit adapted to determine an emission ratio for each frame of the received video data and to determine a voltage of a driving power source for each frame based on the emission ratio of each frame and a power source supply unit adapted to generate and output the voltage of the driving power source for each frame, wherein the data processing unit is further adapted to vary the voltage of the driving power source in one or more small intervening steps when a voltage based on the emission ratio has changed more than a predetermined amount between a current frame to an immediately preceding frame.

The data processing unit can be further adapted to determine a difference in the voltage of a driving power source between the current frame and the immediately preceding frame. The data processing unit can include a data summing unit adapted to obtain the emission ratio for each frame, a look-up table adapted to store a voltage of the driving power source that corresponds to each emission ratio determined by the data summing unit and a signal processing unit adapted to output control signals to the power source supply unit based on the voltage of the driving power source gleaned from the look-up table. The number of intervening voltage steps can be based on a size of the difference in voltage between the current frame and the immediately preceding frame. No intervening steps can be inserted when a voltage of the driving power source for the current frame is less than that of the immediately preceding frame. The voltage of the driving power source can be lower for frames having high emission ratios than for frames having low emission ratios. The voltage of the driving power source can be transmitted to at least one selected from the group consisting of the pixel unit, the data driver and the scan driver.

According to another aspect of the present invention, there is provided an electron emission display that includes a plurality of first electrodes and a plurality of second electrodes, a pixel unit adapted to display an image corresponding to voltages applied to the first and the second electrodes, a data driver adapted to receive video data, to generate data signals and to transmit the data signals to the first electrodes, a scan driver adapted to transmit scan signals to the second electrodes, a data processing unit adapted to determine an emission ratio for each frame of the received video data and to determine a voltage of a driving power source for each frame based on the emission ratio of each frame, a timing controller adapted to control the data driver and the scan driver and to control the voltage of the driving power source through the data processing unit and a power source supply unit adapted to generate and output the voltage of the driving power source for each frame, wherein the timing controller is further adapted to vary the voltage of the driving power source in one or more small intervening steps when a voltage based on the emission ratio has changed more than a predetermined amount between a current frame to an immediately preceding frame.

The data processing unit can be further adapted to determine a difference in the voltage of a driving power source between the current frame and the immediately preceding frame. The data processing unit can include a data summing unit adapted to obtain the emission ratio for each frame, a look-up table adapted to store a voltage of the driving power source that corresponds to each emission ratio determined by the data summing unit and a signal processing unit adapted to output control signals to the power source supply unit based on the voltage of the driving power source gleaned from the look-up table.

According to yet another aspect of the present invention, there is provided a method of driving an electron emission display, the method including summing video data input in a current frame when the voltage of a driving power for an immediately preceding frame is a first voltage, determining an emission ratio of a pixel unit for the current frame from a magnitude of the summed video data, determining the voltage of the driving power source as a second voltage that corresponds to the emission ratio of the current frame and inserting one or more small intervening steps when the second voltage is different by more than a predetermined amount from the first voltage.

The number of intervening voltage steps can be based on a size of the difference between the second voltage and the first voltage. The number of intervening voltage steps is based on a size of the difference between the second voltage and the first voltage. The inserting step can include determining a magnitude of a difference between the second voltage and the first voltage and determining a number of intervening steps from the magnitude of the voltage difference. The inserting step can include determining whether the second voltage is higher than the first voltage and inserting the intervening steps only when the second voltage is higher than the first voltage.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates the structure of an electron emission display;

FIG. 2 illustrates the structure of an electron emission display according to the present invention;

FIG. 3 is a graph illustrating change in brightness of a pixel of the electron emission display illustrated in FIG. 2;

FIG. 4 illustrates the structure of a data processing unit used in the electron emission display of FIG. 2;

FIGS. 5A and 5B are graphs illustrating change in voltage of the driving power source output from the power source supply unit used in the electron emission display of FIG. 2;

FIG. 6 is a perspective view illustrating the pixel unit used in the electron emission display illustrated in FIG. 2; and

FIG. 7 is a sectional view illustrating the pixel unit used in the electron emission display illustrated in FIG. 2.

### DETAILED DESCRIPTION OF THE INVENTION

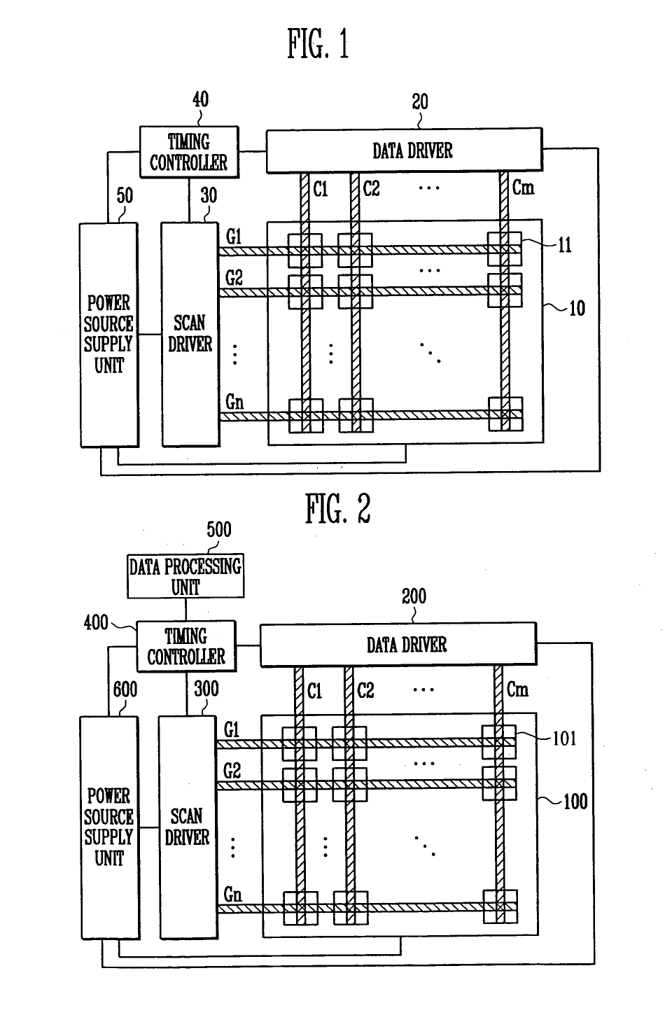

Turning now to FIG. 1, FIG. 1 illustrates the structure of an electron emission display. Referring to FIG. 1, the electron emission display includes a pixel unit 10, a data driver 20, a scan driver 30, a timing controller 40, and a power source supply unit 50. In the pixel unit 10, a plurality of cathode electrodes C1, C2, . . . , and Cm are arranged in a column direction, a plurality of gate electrodes G1, G2, . . . , and Gn are arranged in a row direction, and electron emission units are provided at the intersections between the cathode electrodes C1, C2, . . . , and Cm and the gate electrodes G1, G2, . . . , and Gn to form pixels 11. Alternatively, the gate electrodes G1, G2, . . . , and Gn can instead be arranged in the column direction and the cathode electrodes C1, C2, . . . , and Cm can be arranged in the row direction. Hereinafter, it is assumed that the cathode electrodes C1, C2, . . . , and Cm are arranged in the column direction and the gate electrodes G1, G2, . . . , and Gn are arranged in the row direction. The pixel unit 10 controls differences in voltage between the cathode electrodes and the gate electrodes when the brightness deteriorates in accordance with the lives of the electron emission units so that more electrons are emitted from the electron emission units to compensate for brightness.

The data driver 20 generates data signals using image signals and is connected to the [symbol] transmits the data signals to the cathode electrodes C1, C2, . . . , and Cm. The data driver 20 generates electrode signals for turning on and off the pixels 11 formed at the intersections between selected cathode electrodes C1, C2, . . . , and Cm and gate electrodes G1, G2, . . . , and Gn. The scan driver 30 is connected to the gate electrodes G1, G2, . . . , and Gn and selects one gate electrode among the plurality of gate electrodes G1, G2, . . . , and Gn arranged in the row direction so that the data signals can be transmitted to the pixels 11 connected to the gate electrodes G1, G2, . . . , and Gn. The timing controller 40 transmits data driving control signals and scan driving control signals to the data driver 20 and the scan driver 30 to control the operations of the data driver 20 and the scan driver 30. The power source supply unit 50 generates power and transmits the generated power to the pixel unit 10, the data driver 20, the scan driver 30, and the timing controller 40 so that the pixel unit 10, the data driver 20, the scan driver 30 and the timing controller 40 can be driven.

When the electron emission display having the above-described structure emits light having a low brightness, the difference between a bright color and a dark color is reduced so that contrast deteriorates so that the picture quality deteriorates. When all of the pixels included in the pixel unit emit light of a high brightness, the amount of current that flows through the pixel unit increases so that it is necessary for the power source supply unit to supply more current.

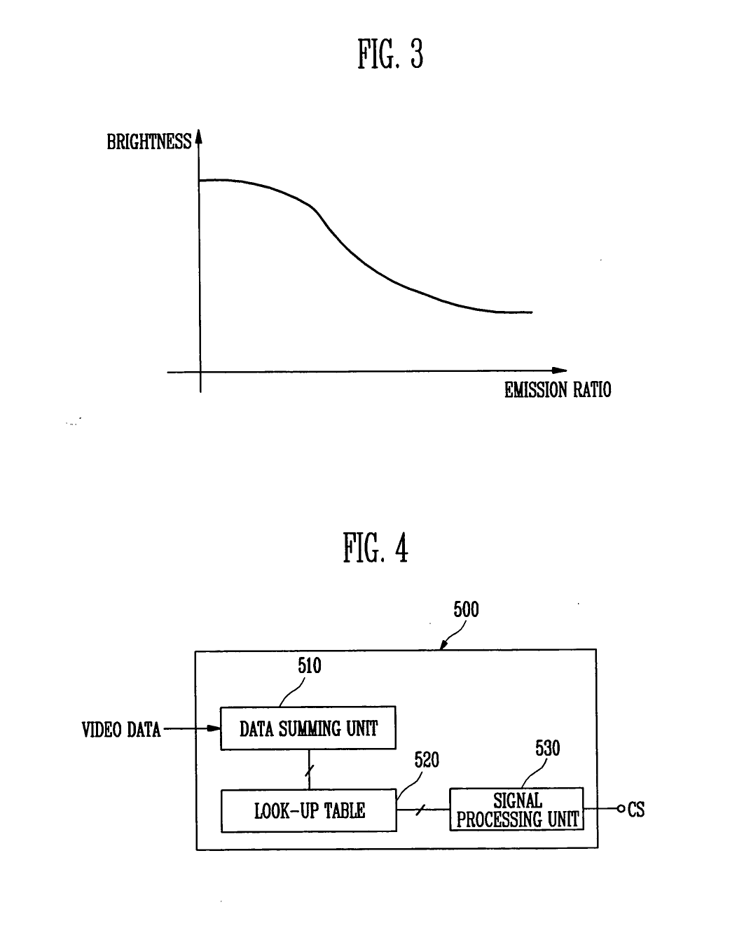

Turning now to FIGS. 2 and 3, FIG. 2 illustrates the structure of an electron emission display according to the present invention and FIG. 3 is a graph illustrating the change in brightness of a pixel of the electron emission display illustrated in FIG. 2 versus emission ratio. Referring to FIGS. 2 and 3, the electron emission display includes a pixel unit 100, a data driver 200, a scan driver 300, a timing controller 400, and a data processing unit 500.

In the pixel unit 100, a plurality of cathode electrodes C1, C2, . . . , and Cm are arranged in a column direction, a plurality of gate electrodes G1, G2, . . . , and Gn are arranged in a row direction, and electron emission units are provided at the intersections between the cathode electrodes C1, C2, . . . , and Cm and the gate electrodes G1, G2, . . . , and Gn to form pixels 101. Alternatively, the gate electrodes G1, G2, . . . , and Gn can instead be arranged in the column direction and the cathode electrodes C1, C2, . . . , and Cm can instead be arranged in the row direction and still be within the scope of the present invention. From now on, it is assumed that the cathode electrodes C1, C2, . . . , and Cm are arranged in the column direction and the gate electrodes G1, G2, . . . , and Gn are arranged in the row direction as illustrated in FIG. 2.

The pixel unit 100 controls the difference in voltage between the cathode electrodes and the gate electrodes when the brightness deteriorates in accordance with the lives of the electron emission units so that more electrons are emitted from the electron emission units to compensate for the brightness. The data driver 200 generates data signals using image signals and is connected to the cathode electrodes C1, C2, . . . , and Cm and transmits the data signals to the cathode electrodes C1, C2, . . . , and Cm. The data driver 200 generates electrode signals for turning on and off the pixels 101 located at the intersections between the selected cathode electrodes C1, C2, . . . , and Cm and gate electrodes G1, G2, . . . , and Gn. The scan driver 300 is connected to the gate electrodes G1, G2, . . . , and Gn and selects one gate electrode among the plurality of gate electrodes G1, G2, . . . , and Gn arranged in the row direction so that the data signals can be transmitted to the pixels 101 connected to the gate electrodes G1, G2, . . . , and Gn. The timing controller 400 transmits signals to the data driver 200 and the scan driver 300 to generate data signals and scan signals and receives control signals from the data processing unit 500 to control the voltage of the driving power source output from a power source supply unit 600.

The data processing unit 500 reduces the brightness of each pixel based on the emission ratio for a particular frame. The emission ratio is the number of pixels that emit light for one frame divided by the total number of pixels in pixel unit 100. That is, the degree of reduction in brightness is large when the emission ratio is large. The degree of reduction is small when the emission ratio is small. As a result, the data processing unit 500 produces images as in FIG. 3. As illustrated in FIG. 3, when the emission ratio is large for a frame, the degree of reduction in brightness is large and so the brightness of the resultant image is low. When the emission ratio is low for a frame, the degree of reduction in brightness is low and so the image is bright.

In the present invention, when the emission ratio is small, the degree of reduction in brightness is small, and the difference between the maximum brightness and the minimum brightness between pixels 101 on the pixel unit 100 for that frame is large meaning that the image contrast for that frame is large. Therefore, the entire brightness of the pixel unit 100 is high as illustrated in FIG. 3, the contrast is high and the image is clearly displayed. When the emission ratio is large so that the degree of reduction in brightness is large, the brightness is low as per FIG. 3 so that excessive power is not required to display the frame.

In the EED of FIG. 2, the power source supply unit 600 changes the voltage level of the generated driving power source in accordance with the degree of reduction in brightness for the frame determined by the data processing unit 500. The brightness of an image can be restricted by either modifying the difference in voltage between the cathode electrodes and the gate electrodes or by modifying the magnitude of the voltage applied to the anode electrodes. This is achieved by controlling the driving power source of the power source supply unit 600 so that one or more voltages among the anode voltage transmitted to the pixel unit 100, the driving voltage for the data driver 200 and the driving voltage for the scan driver 300 is limited.

In addition to reducing the brightness of an image based on emission ratio, the data processing unit 500 also prevents large sudden voltage swings that can cause voltage overshooting and device malfunction. This is achieved by inserting one or more intermediate voltage steps whenever the reduction of brightness based on emission ratios results in a large voltage swing between two frames. The data processing unit 500 causes the power source supply unit 600 to output a intermediate voltage (i.e., a third voltage) whose magnitude is between a voltage of a previous frame (i.e., a first voltage) and a voltage for the same electrode for a subsequent frame (i.e., a second voltage). Instead of changing the voltage suddenly from a first voltage to the second voltage between two frames, the data processing unit 500 causes the power source supply unit 600 to vary the voltage in smaller increments. The number of intermediary steps in voltage varies based on the size of the voltage swing from the first voltage to the second voltage. If the size of the voltage change is large, there will be many intermediary steps consuming a corresponding number of time frames so that the voltage changes in a controlled and gradual manner. If the change in voltage is small, there may be only one or no intermediary voltage steps between when the first voltage and the second voltage are output.

Also, according to the present invention, the timing controller 400 and the data processing unit 500 are divided into different blocks. However, the timing controller 400 and the data processing unit 500 can instead be combined together as a single block so that the data processing unit 500 can directly control the voltages of the driving power source output from the power source supply unit 600.

Referring now to FIG. 4, FIG. 4 illustrates the structure of the data processing unit 500 used in the electron emission display of FIG. 2. Referring to FIG. 4, the data processing unit 500 includes a data summing unit 510, a look-up table 520, and a signal processing unit 530. The data summing unit 510 determines the emission ratio for each frame by summing the data input in one frame and determines that the emission ratio is large when the magnitude of the summed data is large and that the emission ratio is small when the magnitude of the summed data is small.

The look-up table 520 stores data pertaining to the voltage of the driving power source in accordance with the emission ratio. After data summing unit 510 determines the emission ratio for a frame, then look-up table 520 is consulted to find the proper voltage that corresponds to the emission ratio, the voltage having considered the degree of reduction in brightness for the calculated emission ratio. This voltage is then transmitted to signal processing unit 530. When the number of pixels that emit light is large, the emission ratio is large. When the pixel unit 100 has a high emission ratio, the voltage of the driving power source in the look-up table 520 is low so that the brightness of the entire screen can be decreased. When the pixel unit 100 has a low emission ratio, the voltage of the driving power source in the look-up table 520 is high so that the brightness of the entire screen can be increased. The signal processing unit 530 determines the proper voltage of the driving power source corresponding to the emission ratio of the pixel unit 100 through the look-up table 520 using the data summed by the data summing unit 510 to control the timing controller 400 and the power source supply unit 600 so that the voltage of the driving power source is changed.

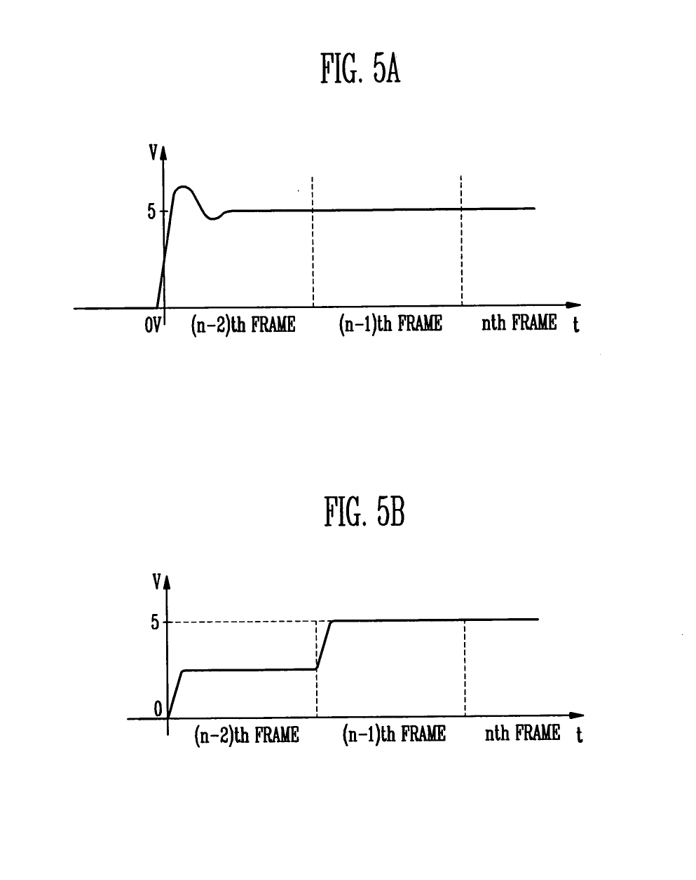

Turning now to FIGS. 5A and 5B, FIGS. 5A and 5B are graphs illustrating the change in the voltage of the driving power source output from the power source supply unit 600 versus time for the electron emission display of FIG. 2. Referring to FIGS. 5A and 5B, when the emission ratio for a frame of the pixel unit 100 is high, the voltage of the driving power source is small so that the brightness is low. When the emission ratio of the pixel unit 100 is low, the voltage of the driving power source is large so that the brightness is high. When the image displayed by the pixel unit 100 changes from a frame having a high emission ratio into a frame having a low emission ratio, the voltage of the driving power source must change from a low value to a high value. As illustrated in FIG. 5A, when the voltage of the driving power source suddenly increases by a large amount, an overshoot occurs. As a result, one of the pixel unit 100, the data driver 200, and the scan driver 300 that receives the overshooting driving power source for operation does not operate in a stable manner because of this overshoot.

In order to correct for this problem of overshoot brought about by a large and sudden change in voltage, the present invention resolves this problem by inserting one or more intermediary voltages (or third voltages) so that the voltage changes slowly in steps instead of all at once. FIG. 5B illustrates the scenario where one intermediary step is inserted at the (n-2) th frame to prevent overshooting. As a result, when the voltage of the driving power source of one of the pixel unit 100, the data driver 200, and the scan driver 300 changes, it is possible to prevent the voltage from suddenly increasing and overshooting so that the drivers can operate in a stable manner. In the present invention, the number of steps through which the driving voltage changes is dependent upon the size of the change in voltage. When the difference in driving voltage is large, the voltage of the driving power source changes the voltage through many steps. The driving voltage changes from the initial voltage into the intermediate voltage and then, from the intermediate voltage into the target voltage when the difference in voltage between the initial voltage and the target voltage is large. This occurs when the change in brightness of an image between one frame and the next frame is large. When this occurs, the voltage is first changed into the intermediate voltage and then for the following frame, the voltage increases to the target voltage so that the difference in voltage between the target voltage and the intermediate voltage and between the intermediate voltage and the initial voltage are not as large. As a result, the difference in the brightness of an image is also not too large.

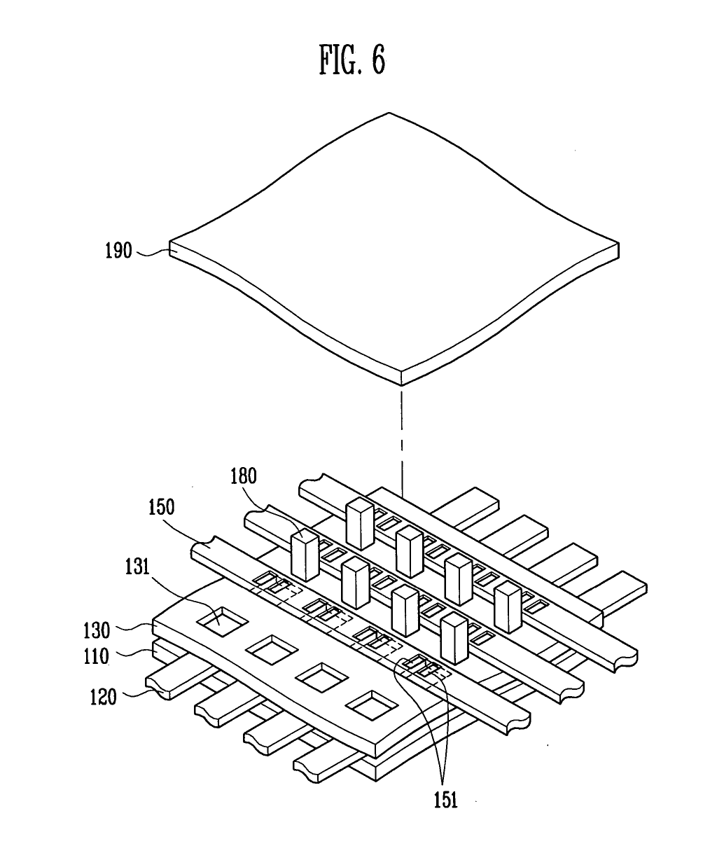

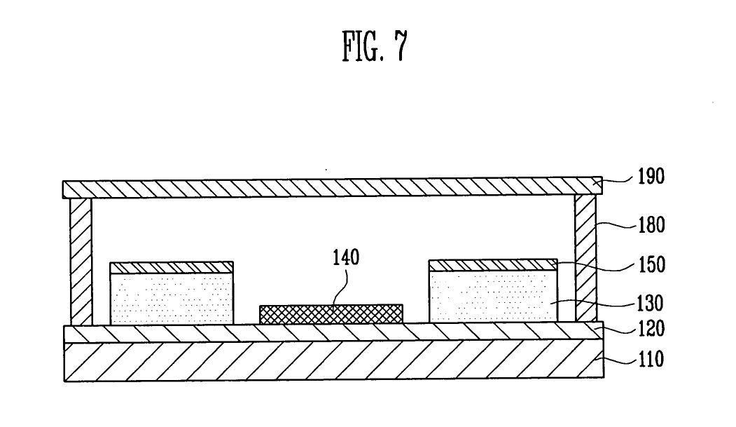

Turning now to FIGS. 6 and 7, FIG. 6 is a perspective view illustrating the pixel unit used for the electron emission display illustrated in FIG. 2 and FIG. 7 is a sectional view illustrating the pixel unit. Referring to FIGS. 6 and 7, the electron emission display includes a lower substrate 110, an upper substrate 190, and spacers 180. Cathode electrodes 120, an insulating layer 130, electron emission units 140, and gate electrodes 150 are formed on the lower substrate 110. On upper substrate 190, anode electrodes and a fluorescent layer are formed thereon.

One or more cathode electrodes 120 having a stripe pattern are formed on the lower substrate 110 and the insulating layer 130 having a plurality of first grooves 131 that expose parts of the cathode electrodes 120 is formed on the cathode electrodes 120. The gate electrodes 150 are formed on the insulating layer 130. A plurality of second grooves 151 of a uniform size are formed in the gate electrodes 150. The second grooves 151 are formed at locations that correspond to the first grooves 131. The electron emission units 140 are positioned on the cathode electrodes 120 at locations where the first grooves 131 and the second grooves 151 coincide with each other.

Glass or silicon can be used as the lower substrate 110. A transparent substrate such as a glass substrate is preferably used for the electron emission units 140 when the electron emission units 140 are formed of paste by bottom surface exposure. The cathode electrodes 120 supply the data signals or the scan signals applied from the data driver (not shown) or the scan driver (not shown) to the electron emission units 140. The cathode electrodes 120 are formed of indium tin oxide (ITO). The insulating layer 130 is formed on the lower substrate 110 and on the cathode electrodes 120 to electrically insulate the cathode electrodes 120 and the gate electrodes 150 from each other. The gate electrodes 150 are formed on the insulating layer 130 in a predetermined shape, for example, in stripes to intersect the cathode electrodes 120 and supply the data signals or the scan signals applied from the data driver 200 or the scan driver 300 to the pixels 101. The gate electrodes 150 are formed of metal having excellent conductivity such as Au, Ag, Pt, Al, Cr or an alloy of the above.

The electron emission units 140 are electrically connected to the cathode electrodes 120 exposed by the first apertures 131 of the insulating layer 130 and are preferably formed of materials that emit electrons when an electric field is applied, such materials can be carbon based materials including nano meter sized material, carbon nano tube, graphite, graphite nano fiber, diamond-phase carbon, C₆₀, silicon nano wire or materials obtained by combining the above.

The upper substrate 190 includes a fluorescent layer that emits light when electrons collide with the fluorescent layer. An anode electrodes are also present to hold the fluorescent layer at a potential that attracts the emitted electrons to the upper substrate 190. The spacers 180 keep the lower substrate 110 and the upper substrate 190 separated from each other by a distance.

According to the electron emission display of the present invention and the method of driving the same, the voltage of the driving power source changes through one or many steps to prevent overshoting so that the drivers can operate in a stable manner. The degree of restricting the brightness varies based on the emission ratio of the pixel unit so that contrast can be improved, leading to improved picture quality while preventing the power source supply unit from having to put out an excessively large current.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. An electron emission display, comprising:
a plurality of first electrodes and a plurality of second electrodes;
a pixel unit adapted to display an image corresponding to voltages applied to the first and the second electrodes;
a data driver adapted to receive video data, to generate data signals and to transmit the data signals to the first electrodes;
a scan driver adapted to transmit scan signals to the second electrodes;
a data processing unit adapted to determine an emission ratio for each frame of the received video data and to determine a voltage of a driving power source for each frame based on the emission ratio of each frame; and
a power source supply unit adapted to generate and output the voltage of the driving power source for each frame, wherein the data processing unit is further adapted to vary the voltage of the driving power source in one or more small intervening steps when a voltage based on the emission ratio has changed more than a predetermined amount between a current frame to an immediately preceding frame.

2. The electron emission display of claim 1, wherein the data processing unit is further adapted to determine a difference in the voltage of a driving power source between the current frame and the immediately preceding frame.

3. The electron emission display of claim 2, wherein the data processing unit comprises:
a data summing unit adapted to obtain the emission ratio for each frame;
a look-up table adapted to store a voltage of the driving power source that corresponds to each emission ratio determined by the data summing unit; and
a signal processing unit adapted to output control signals to the power source supply unit based on the voltage of the driving power source gleaned from the look-up table.

4. The electron emission display of claim 2, wherein the number of intervening voltage steps is based on a size of the difference in voltage between the current frame and the immediately preceding frame.

5. The electron emission display of claim 1, wherein no intervening steps are inserted when a voltage of the driving power source for the current frame is less than that of the immediately preceding frame.

6. The electron emission display of claim 5, wherein the voltage of the driving power source is lower for frames having high emission ratios than for frames having low emission ratios.

7. The electron emission display of claim 1, wherein the voltage of the driving power source is transmitted to at least one selected from the group consisting of the pixel unit, the data driver and the scan driver.

8. An electron emission display, comprising:
a plurality of first electrodes and a plurality of second electrodes;
a pixel unit adapted to display an image corresponding to voltages applied to the first and the second electrodes;
a data driver adapted to receive video data, to generate data signals and to transmit the data signals to the first electrodes;
a scan driver adapted to transmit scan signals to the second electrodes;
a data processing unit adapted to determine an emission ratio for each frame of the received video data and to determine a voltage of a driving power source for each frame based on the emission ratio of each frame;
a timing controller adapted to control the data driver and the scan driver and to control the voltage of the driving power source through the data processing unit; and
a power source supply unit adapted to generate and output the voltage of the driving power source for each frame, wherein the timing controller is further adapted to vary the voltage of the driving power source in one or more small intervening steps when a voltage based on the emission ratio has changed more than a predetermined amount between a current frame to an immediately preceding frame.

9. The electron emission display of claim 8, wherein the data processing unit is further adapted to determine a difference in the voltage of a driving power source between the current frame and the immediately preceding frame.

10. The electron emission display of claim 9, wherein the data processing unit comprises:
a data summing unit adapted to obtain the emission ratio for each frame;
a look-up table adapted to store a voltage of the driving power source that corresponds to each emission ratio determined by the data summing unit; and
a signal processing unit adapted to output control signals to the power source supply unit based on the voltage of the driving power source gleaned from the look-up table.

11. A method of driving an electron emission display, the method comprising:
summing video data input in a current frame when the voltage of a driving power for an immediately preceding frame is a first voltage;
determining an emission ratio of a pixel unit for the current frame from a magnitude of the summed video data;
determining the voltage of the driving power source as a second voltage that corresponds to the emission ratio of the current frame; and
inserting one or more small intervening steps when the second voltage is different by more than a predetermined amount from the first voltage.

12. The method of claim 11, wherein a number of intervening voltage steps is based on a size of the difference between the second voltage and the first voltage.

13. The method of claim 11, wherein the second voltage of the driving power source is large when the emission ratio for the current frame is high and is small when the emission ratio is low.

14. The method of claim 13, wherein the inserting step further includes:
determining a magnitude of a difference between the second voltage and the first voltage; and
determining a number of intervening steps from the magnitude of the voltage difference.

15. The method of claim 11, wherein the inserting step includes determining whether the second voltage is higher than the first voltage and inserting the intervening steps only when the second voltage is higher than the first voltage.
